(19) United States
(12) Patent Application Publication
(10) Pub. No.: US 2007/0044593 A1
(43) Pub. Date: Mar. 1, 2007

(54) Open-end cable and tubing ratcheting socket wrench

(76) Inventor: Scott Seaman Murdoch SR., Meriden, CT (US)

Correspondence Address: SCOTT MURDOCH, 57 HILLSIDE ST., MERIDEN, CT, 06451, US

(21) Appl. No.: 11/162,210

(22) Filed: Sep. 1, 2005

(51) Int. Cl. B25B 13/46

(52) U.S. Cl. 81/58.2; 81/60

(57) ABSTRACT

Open-end ratcheting socket wrench, unidirectional in rotation, reversible by flipping the wrench body to its other side. The socket has a slot on one side to fit over the cable, tubing, or pipe being worked on. There are three pawls so a minimum of two are in contact with ratchet gear at all times since one will be disengaged with the gear when the open face is adjacent to the pawl. The intended use of the tool is to loosen or tighten a fitting attached to a cable, tubing, or pipe especially in a recessed area without having to reposition the wrench onto the fitting using a ratcheting action. The socket is then backed away from the work piece, the slot in the socket realigned with the slot in the body and the wrench and socket removed from the cable, tubing, or pipe.

### FIELD OF THE INVENTION

The invention relates to hand tools in general and more particularly to an open-end ratcheting socket wrench designed more specifically for tightening or loosening a nut or fitting which is connected to a cable, tubing, or pipe and as a result would render the typical socket wrench useless in which case.

### BACKGROUND OF THE INVENTION

An open-end ratchet wrench can be useful in many different applications such as coaxial cable connections, video distribution cable, plumbing, gas line, and even transmission and brake lines.

Many ratcheting type wrenches have been designed for such type uses, however, the ratcheting mechanisms are sloppy and complex and subject to malfunction due to the many moving parts involved and do not give mention to a socket extension to keep the tool away from the work piece in tight areas. The tool being discussed here for all practical purposes has only one moving part. The one moving part being discussed here is the ratchet gear itself. Other wrenches can be awkward and clumsy in the sense that if you are working in a tight area, such as a four way cable splitter, the body of a typical wrench, ratcheting or not, tends to be inhibited in movement due to the connection ports of the splitter being so close. The press fitted slotted socket solves this problem by keeping the main body of the wrench away from the work piece, thus allowing free movement of the body while loosening or tightening the work piece. To further reduce the moving parts involved, we made the tool with a socket extension on both sides of the tool, thus making it reversible by simply flipping the tool over.

### SUMMARY OF THE INVENTION

The open-end cable and tubing ratcheting socket wrench is comprised of a main body or housing with an open end (7). The housing encases three spring-loaded (13) pawls (12), which are inserted inside the cavities within the housing (9) and (10) for even and constant contact with the ratchet gear (6) with a minimum of two pawls at all times because when the open end of the ratchet gear (4) comes adjacent to one of the pawls, that pawl will, of course have no contact. That is when the other two pawls take over, and so on as the open end of the ratchet gear comes adjacent to each pawl. The body includes a handle (11). The ratchet gear, which is inserted into the gear housing (8) is open ended as well as the protruding socket extension (2), which is press fitted into the ratchet gear (3) and (5). Thus, when the open end of the main body and the socket attached to the ratchet gear are aligned, the tool easily fits over the cable, tubing, or pipe to be worked on.

The tool is used by slipping the aligned open end (1) of the socket and body over the cable or tubing to be worked on and onto the work piece. The tool then ratchets like any normal socket wrench would operate. Once the user is done tightening or loosening the work piece, he then backs it away from the work piece, realigns the open end of the socket with the open end in the body and slides it off of the cable or tubing being worked on. To use the tool in reverse, one simply flips the tool around to use the other end of the socket.

### BRIEF DESCRIPTION OF THE DRAWINGS

Other objects and advantages appear hereinafter in the following description and claims. The accompanying drawings show, for the purpose exemplification, without limiting the invention or the appended claims, certain practical embodiments illustrating the principals of this invention, wherein:

FIG. 1 is a front and side view of the socket insert press fitted into the ratchet gear;

FIG. 2 is a view in front elevation of the ratchet gear;

FIG. 3 is a view in front of the wrench housing;

FIG. 4 is a view in front elevation of the preferred embodiment of the complete wrench assembly of the present invention;

FIG. 5 is a view in side elevation of the complete wrench assembly;

FIG. 6 is a view in front elevation of the pawls removed from the body of the wrench shown in FIG. 4 to show their shape and position;

FIG. 7 is a view in front elevation of the tension springs used to the pawls in position relative to the ratchet gear

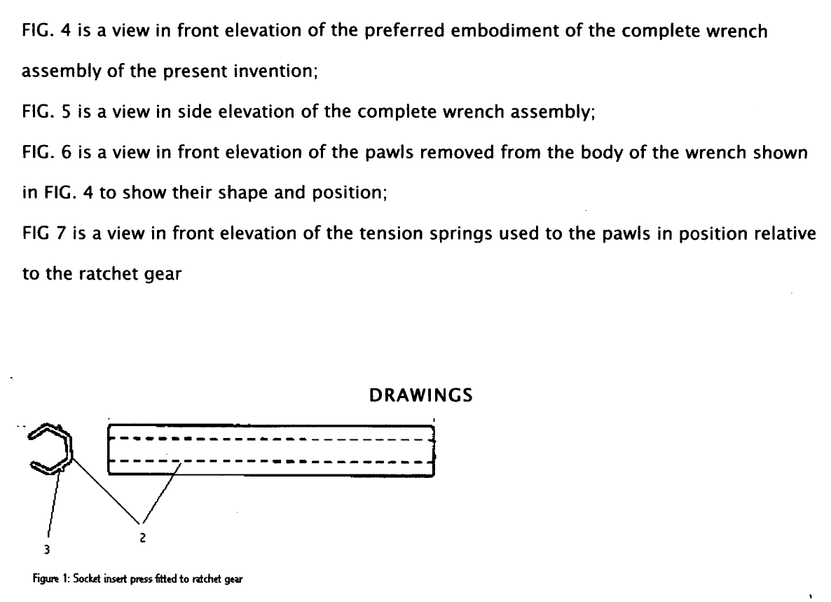

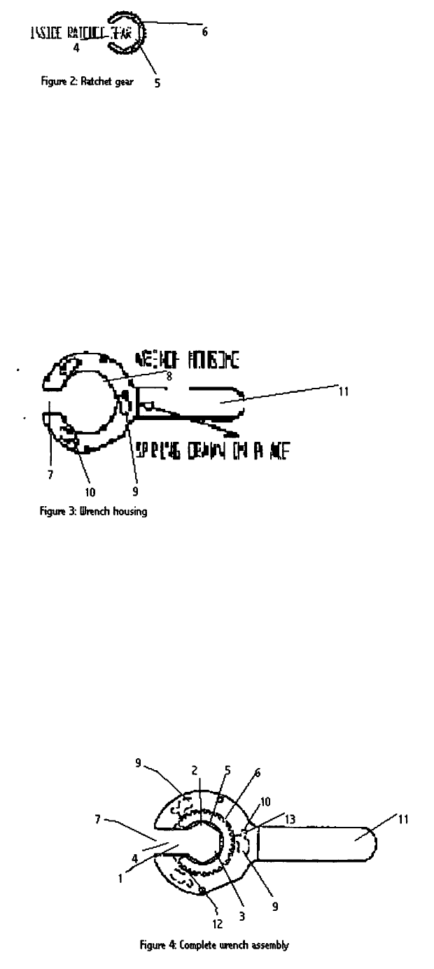

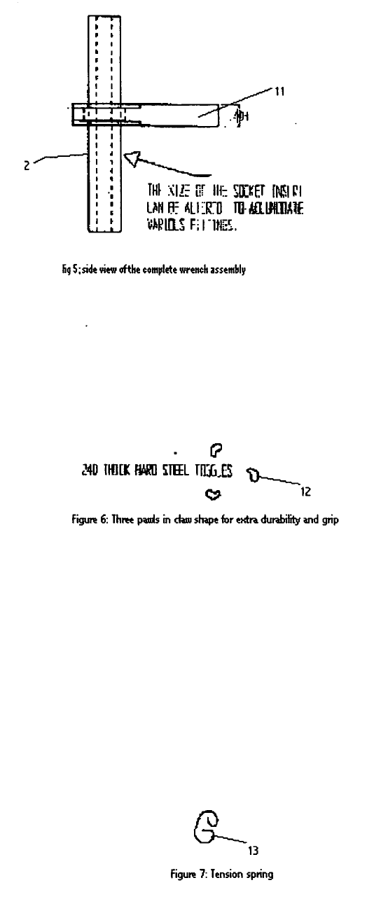

### DESCRIPTION

Open ended ratcheting socket wrench with a socket that extends to either side. One side for clockwise operation, the other for counterclockwise. The tool is more specifically designed for use on coaxial cable, video distribution cable, tubing, plumbing, gas line, transmission and brake lines, or any other application where the work piece has a cable, wire, pipe or tube attached to it that would normally require the use of an open end wrench or pipe wrench which would have to be removed from the work piece once the wrench cannot be turned any more due to an obstacle in the way, then replaced so it can be turned again. The open-ended ratcheting socket wrench described here is designed to stay on the work piece until the job is completed.

Definition List 1

| Term | Definition |
|---|---|
| Body or wrench | That which houses the tension springs |
| housing | and pawls and allows ratchet gear to |
| | rotate freely within it. |
| Ratchet gear | Rotates freely within wrench housing and |
| | makes contact with pawls which allow |
| | only unidirectional movement. |
| Slotted socket | Press fitted into ratchet gear, slides over |
| | cable, tubing, or pipe and onto work |
| | piece. Once work is complete on work |
| | piece, socket can then be backed away |
| | from work piece, The slot in the socket |
| | is then realigned with the slot in the |
| | body and removed from the cable, |
| | tubing, or pipe. |
| Tension springs | Provide tension on the pawls so pawls |
| | maintain constant and even contact with |
| | ratchet gear. |
| Pawls | Provide grip against the teeth in the |
| | ratchet gear so gear allows only |
| | unidirectional movement. |

What is claimed is:

1. An open-ended hand held ratcheting socket wrench designed exclusively for cable television RG type fittings, cable distribution trunk fittings, plumbing fittings, natural gas line fittings, transmission line fittings, brake line fittings or any other type of fitting whereby the fitting, being a hex shape fitting may have a cable, pipe, or tubing protruding from either end that would normally inhibit the use of a normal closed end socket wrench due to the inability to fit the socket to the work piece because of the protruding cable, tubing, or pipe blocking access to the work piece.

2. A unique, fixed within the body yet rotating, open ended, extended socket on each side of the tool for reaching into hard to access areas, yet keeping the main body of the ratchet wrench away from the work area so as to aid in maneuverability. The socket being extended on each side of the tool making the tool reversible by simply flipping the tool itself around.

3. A center gear with an open end wide enough to slide over a coaxial cable, tubing or pipe and having a hexagonal shape the same size as the outside diameter of the extended socket mentioned in claim 2. Which said extended socket is press fitted into said center gear.

4. A unidirectional ratcheting mechanism implemented by the use of three equally spaced and unilateral pawls, which are spring loaded within the main body against the center gear mentioned in claim 3. The purpose of the three pawls is that due to the open ended nature of the center gear; one pawl will not be in contact with the gear causing it to miss. Because there are a total of three pawls, a minimum of two pawls will be in contact with the gear at all times.

5. A claw shaped pawl for better wear and grabbing strength.
